(19) United States
(12) Patent Application Publication
(10) Pub. No.: US 2018/0079601 A1
(43) Pub. Date: Mar. 22, 2018

(54) PLATFORM FOR BAGGAGE CART AND BAGGAGE HANDLING SYSTEM AND METHOD OF USING THE SAME

(71) Applicant: CYCLECT ELECTRICAL ENGINEERING PTE LTD, Singapore (SG)

(72) Inventors: Weng Wah KHONG, Singapore (SG); Hideharu YANAGI, Singapore (SG)

(73) Assignee: CYCLECT ELECTRICAL ENGINEERING PTE LTD, Singapore (SG)

(21) Appl. No.: 15/555,973

(22) PCT Filed: Aug. 20, 2015
(86) PCT No.: PCT/SG2015/050268

§ 371 Date: Sep. 6, 2017

(30) Foreign Application Priority Data
Mar. 6, 2015 (SG) 10201501748Q
Jul. 22, 2015 (SG) 1020150694U

(51) Int. Cl. B65G 47/49; B62B 3/00; B62B 3/04; B62B 3/10; B60P 1/52; B65G 47/82; B64F 1/36

(52) U.S. Cl. CPC B65G 47/49; B62B 3/005; B62B 3/04; B62B 3/106; B65G 2201/0264; B65G 47/82; B64F 1/368; B62B 2202/24; B60P 1/52

(57) ABSTRACT

The present invention relates to baggage handling systems and in particular a platform for moving baggage in multiple directions and methods of using the same with baggage carts and a baggage handling system to reduce human interaction and intervention with the baggage and for tracking of baggage.

### FIELD OF THE INVENTION

The present invention relates to baggage handling systems and in particular, but not exclusively, to a platform or a baggage cart and a baggage handling system with the platform and method of using the same for handling and tracking baggage.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

For larger aircraft a container is packed on the ground and the entire container is placed into the aircraft. However, the loading and unloading of baggage and cargo for narrow-body, non-containerised aircraft such as the airbus A320 and Boeing 737 is very labour intensive. A typical traditional baggage handling system for such smaller aircraft is labour intensive as the processes involved at certain stages are very manual which require several baggage handlers to carry out the processes. Such stages include the sorting of baggage to be loaded onto a particular trolley or cart for a particular flight, transporting the trolley to the particular aircraft and loading of baggage onto the aircraft. Baggage trolleys or carts which are typically used in such systems are merely in the form of a container for holding baggage for transportation from one location to another.

In order to sort the baggage at the initial stage, baggage handlers are required to identify the bags to be loaded onto the trolley designated for a particular flight. Prior to loading on the trolley, baggage handlers are required to scan each of the tags on the baggage with a hand-held barcode scanner before manually transferring the baggage onto the trolley. After the trolleys for a particular flight have been filled, baggage handlers are again required to manually link the trolleys together. A tractor driver is then required to connect a tractor to the linked up trolleys and operate the tractor to deliver the trolleys to the designated aircraft. The trolleys are then lined up for loading of the baggage onto the aircraft. At this stage, baggage handlers are required again for manually removing the baggage from the trolleys and loading them onto a conveyor belt loader for loading onto the aircraft. Furthermore, baggage handlers are also required to arrange the baggage by moving them further into the belly of the aircraft and stacking them up accordingly.

The reverse cycle of handling of baggage when being unloaded from the aircraft and transporting the baggage to the airport terminal building follows processes similar to the above-mentioned processes which are very labour intensive.

As such traditional baggage handling systems require a great amount of human interaction and intervention with the baggage, the possibility of injury or human errors or oversight is increased which may result in mishandled bags. Furthermore, there is also a higher possibility for unwanted “tampering” with the bags.

Therefore, there is a need to have a baggage cart and a system and method that is less manual minimising human interaction with the baggage but at the same time able to track the baggage for security reasons.

The present invention seeks to provide a baggage a baggage handling system and method that overcomes, or at least alleviates, the above-mentioned problems. In particular, but not exclusively, to provide a system and method of transferring baggage from one location to another location from one location to another location that reduces human interaction and intervention with the baggage and for tracking of baggage.

### SUMMARY OF THE INVENTION

In accordance with a first aspect of the invention relates to a link platform for transferring baggage from one location to another location comprising an x-y conveying system capable of movement backwards or forwards in an x direction and capable of movement backwards or forwards in a y direction wherein the y direction is at an angle to the x direction.

Another aspect of the invention relates to a moveable cart comprising; a container for receiving and/or holding baggage, the container comprising a base and a top side connected by containment sides, and a link platform comprising an x-y conveying system capable of movement backwards or forwards in an x direction and capable of movement backwards or forwards in a y direction, wherein the link platform extends at an angle from one of the containment sides, the x direction substantially parallel to the containment side from which it extends and the y direction at an angle to the x direction for movement of baggage into or out of the cart.

Another aspect of the invention relates to a method for transferring baggage from one location to another location comprising moving a baggage on a link platform comprising an x-y conveying system; moving the baggage on the link platform in one of several directions comprising backwards or forwards in an x direction; or backwards or forwards in a y direction.

Other aspects and features of the present invention will become apparent to those of ordinary skill in the art upon review of the following description of specific embodiments of the invention in conjunction with the accompanying figures.

### BRIEF DESCRIPTION OF DRAWINGS

The present invention will now be described, by way of illustrative example only, with reference to the accompanying drawings.

FIG. 1 is a perspective view of a link platform for transferring baggage from one location to another location in accordance with an embodiment of the present invention. 1A is an embodiment with a multiple belt system, 1B is an embodiment with a multiple directional roller IC is an example of a multiple directional roller and 1D is a schematic of the concept of use of the multidirectional roller.

FIG. 2 shows a link platform conveyor system for sorting baggage, which may be part of a baggage handling system, in accordance with an embodiment of the present invention.

FIG. 3, shows examples of RFID tags of a baggage handling system in accordance with an embodiment of the present invention.

FIG. 4 is a perspective view of a link platform attached to a moveable cart for transferring baggage into or out of the cart.

FIG. 5 is a perspective view of a link platform attached to a moveable cart such that the link platform can be raised or lowered in relation to the cart.

FIG. 6, is a perspective view of a moveable cart in accordance with an embodiment of the present invention.

FIG. 7 shows conveyer shelving whereby 7A is a cross section of the baggage cart of FIG. 6 and FIG. 7B is a perspective view of a shelf conveyer.

FIGS. 8 illustrates the concept of a self that can be raised or lowered in relation to the cart whereby 8A, 8B and 8C show the baggage cart of FIG. 6 in operation in which each rack of the baggage cart is moveable.

FIG. 9 shows a plurality of the baggage carts of FIG. 6 being lined up for transfer of baggage from one location to another in an automatic fashion.

FIG. 10 is a perspective view of a baggage cart of FIG. 6 in accordance with another embodiment of the present invention.

FIG. 11 is a perspective view of shelves of a baggage cart of FIG. 6 in accordance with another embodiment of the present invention.

FIG. 12 depicts a schematic of a method for transferring baggage from a continuous conveyer to a cart.

FIG. 13 depicts a schematic of a method for transferring baggage to or from an aircraft to or from a baggage cart.

FIG. 14 depicts a schematic of a method for transferring baggage from a cart to one or more continuous conveyer.

FIG. 15 depicts a schematic of a method for transferring baggage from one location to another location.

### DETAILED DESCRIPTION

Current methods for transferring baggage from one location to another location are very labour intensive.

Accordingly, a first aspect of the invention relates to a link platform for transferring baggage from one location to another location comprising an x-y conveying system capable of movement backwards or forwards in an x direction and capable of movement backwards or forwards in a y direction wherein the y direction is at an angle to the x direction.

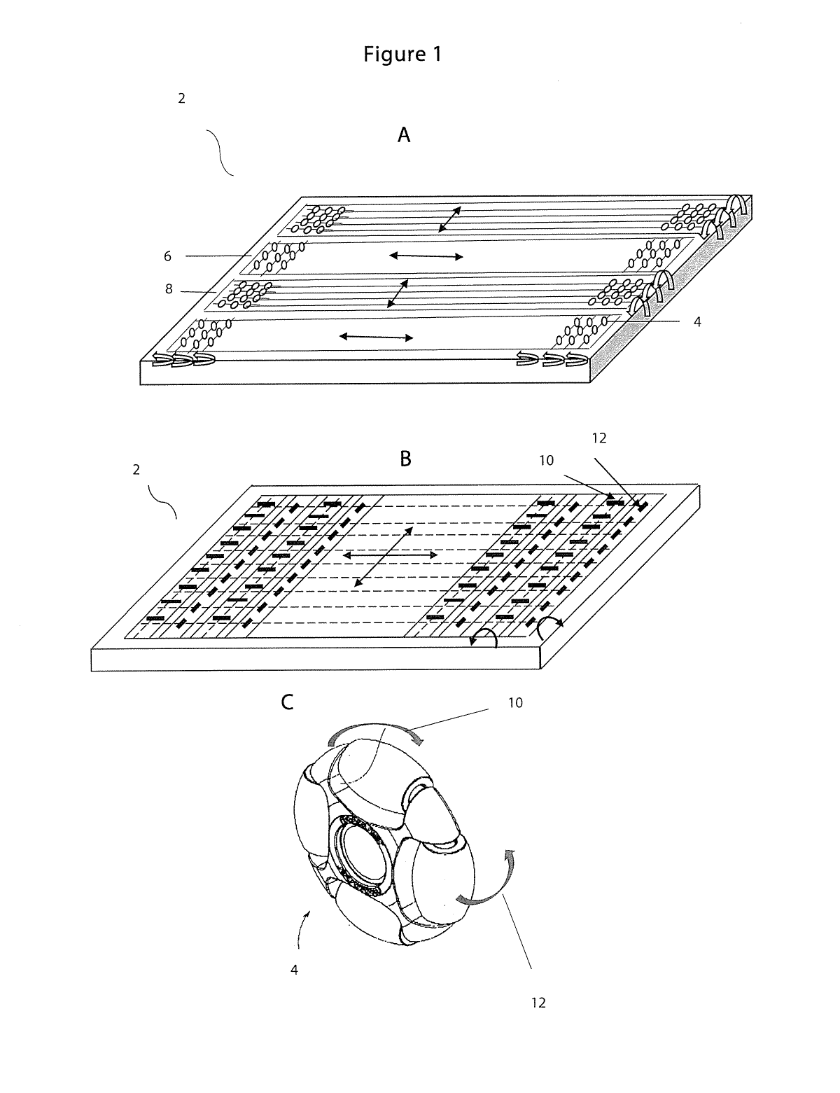

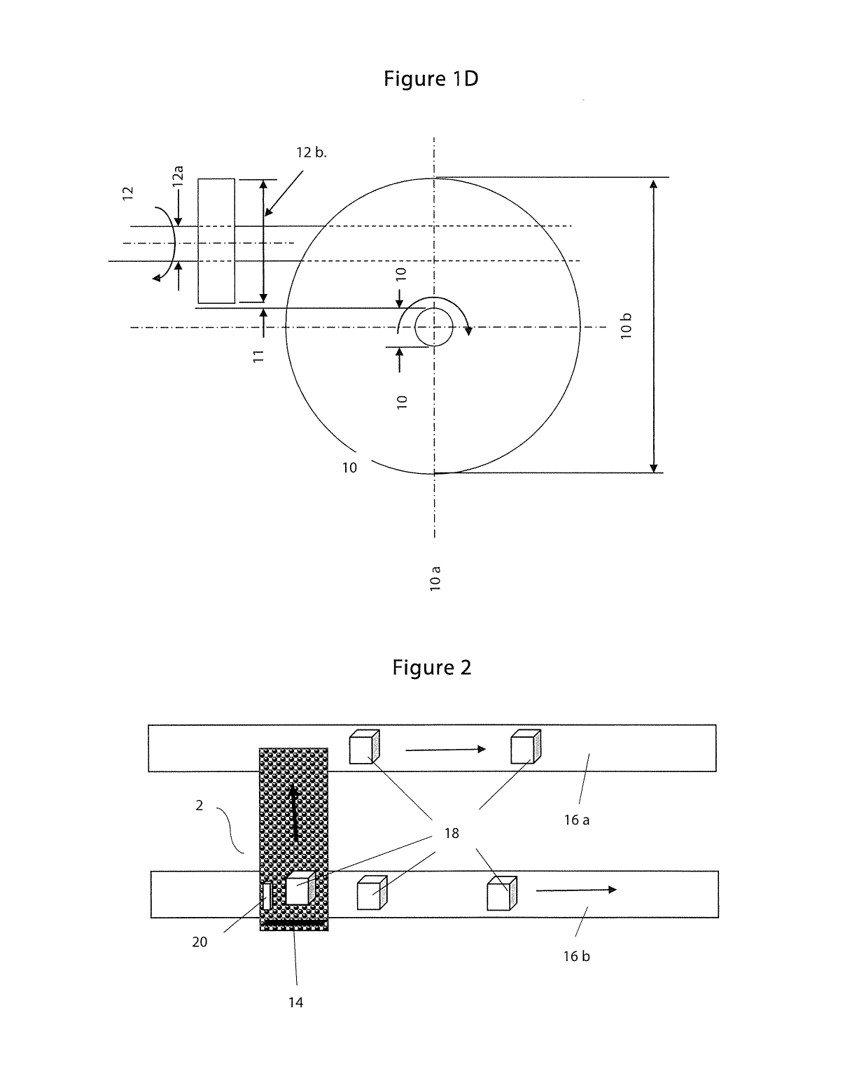

Such a platform has the advantage of moving baggage placed thereon in at least one of several possible directions. Preferably, several possible directions includes at least 3 possible directions. In various embodiments several possible directions includes at least 4 possible directions. Various embodiments of the link platform 2 is depicted in FIG. 1 whereby a plurality of rollers 4 are mounted on a shaft such that they are able to move about the shaft and placed adjacent other shafts similarly mounted with a plurality of rollers 4 to allow movement of an object placed on the link platform 2.

In accordance with another aspect of the present invention, there is provided a conveyor system for sorting baggage. The conveyor system is able to sort or separate baggage to be conveyed to a first location from baggage to be conveyed to other locations as desired, such as a second location, a third location and so on.

In various embodiments the x-y conveying system is achieved by a duel or multi belt layout (FIG. 1 A) comprising at least two belts 6, 8 both capable of movement backwards or forwards placed such that the backwards or forwards direction of one of the at least two belts 6 is at an angle to the backwards or forwards direction of the other of the at least two belts 8. The angle may be any angle from 1 to 179 degrees, or 15 to 165 degrees, or 20 to 160 degrees, or 25 to 155 degrees, or 30 to 150 degrees, or 35 to 145 degrees, or 40 to 140 degrees, or 45 to 135 degrees, or 55 to 130 degrees, or 60 to 125, or 65 to 120 degrees, 70 to 115 degrees, or 75 to 110 degrees, or preferably 80 to 105 degrees, or more preferably 85 to 100 degrees, or most preferably 90 to 95 degrees, or substantially perpendicular or orthogonal. The angle chosen depends on the two directions that movement is required. The closer to a perpendicular relationship the angles are the more useful the x-y conveying system will be at moving objects placed on the link platform in oppositely different directions but any difference that achieves movement in different directions is anticipated to transfer baggage in different directions requiring less manual transfers.

Alternatively, the x-y conveying system is achieved by the roller 4 being in the form of a duel or multi directional roller 4 mounted on the shaft (FIG. 1B) wherein the duel or multi directional roller 4 is able rotate about the shaft in one direction and rotate about an outer portion of the roller in another direction.

Wherein the axis of the two directions of rotation is at an angle to one another. The angle may be any angle from 1 to 179 degrees, or 15 to 165 degrees, or 20 to 160 degrees, or 25 to 155 degrees, or 30 to 150 degrees, or 35 to 145 degrees, or 40 to 140 degrees, or 45 to 135 degrees, or 55 to 130 degrees, or 60 to 125, or 65 to 120 degrees, 70 to 115 degrees, or 75 to 110 degrees, or preferably 80 to 105 degrees, or more preferably 85 to 100 degrees, or most preferably 90 to 95 degrees, or substantially perpendicular or orthogonal. The angle chosen depends on the two directions that movement is required. The closer to a perpendicular relationship the angles are the more useful the x-y conveying system will be at moving objects placed on the link platform in oppositely different directions but any difference that achieves movement in different directions is anticipated to transfer baggage in different directions requiring less manual transfers.

In various embodiments a belt conveying system, X-Y moving belt conveyer can be made by two separate conveyers as depicted in FIG. 1A, a first belt conveyer 6 is for the X direction and a second belt conveyor 8 is for the Y direction. The X-Y movement in this embodiment requires two belt system using at least two sheets of belt. In a roller conveyer system with the use of balls 4 or abacus balls, comprising two modules, a first module 6 is for the X direction and the second module 8 is for the Y direction, the X-Y movement can now be realised.

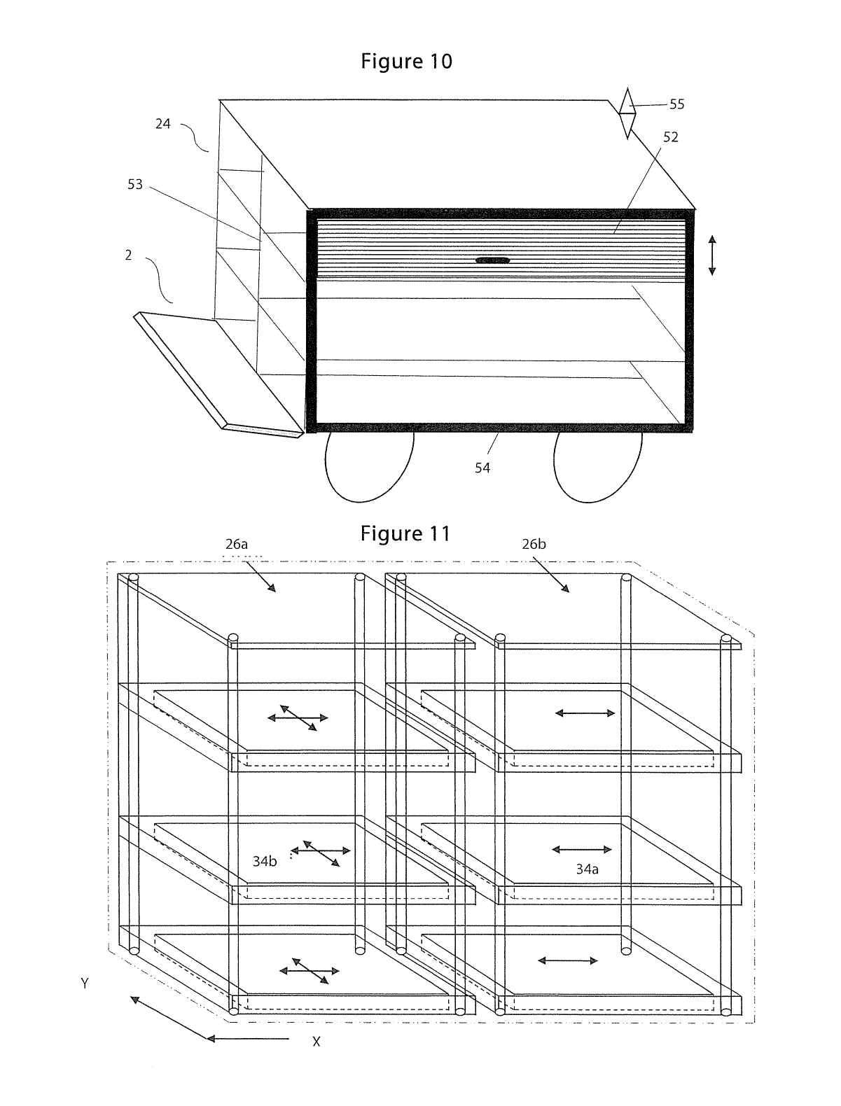

In various embodiments the X-Y conveying system is achieved by an X-Y moving roller as depicted in FIG. 1B and 10, a first axis 10 is for the X direction that moves about the shaft that it is mounded on and a second axis 12 is for the Y direction that moves about an outer band in the same plane as the through hole of the roller 4. The X-Y movement in this embodiment requires two axis that cross each other at an angle as described above. In a roller conveyer system with the use of duel or multidirectional rollers 4, comprising two modules, a first module 10 is for the X direction and the second module 12 is for the Y direction, the X-Y movement can now be realized so as to move smoothly. Referring to Figure ID the structure of the roller 4 comprises two different diameter wheels, one smaller wheel is used for Y-direction movement 12 and the other larger wheel is used for X-direction movement 10.

Referring to FIG. 1B the structure of the link platform are comprised of two deferent diameter wheels, one smaller wheel is used for Y-directional movement and the other larger wheel is used for X-directional movement.

In various embodiments the link platform with x-y conveying system is capable of movement backwards or forwards in an x direction via a belt or roller conveyer and capable of movement in a y direction by a mechanical force such as a plunger or a torque motor.

The multidirectional capability of the link platform has the advantage of transferring baggage from one location to another location with minimum human activity. This may increase productivity, and/or minimize work injuries and/or minimize mistakes due to human error.

In various embodiments the link platform further comprising a radio frequency identification system capable of receiving, storing or transmitting radio frequency.

Referring to FIG. 2 in various embodiments the link platform 2 further comprises a controller, a Radio Frequency Identification (“RFID”) system which has a RFID transceiver 14 which can act as a transmitter and receiver, and a control panel (not shown). The RFID transceiver 14 can transmit and receive via 4G and/or 5G WIFI. Upon activation of the control panel, the baggage 18 will be loaded onto the link platform 2 the RFID transceiver 14 reads a tag associated with the loaded baggage and the information can be used to track the baggage and/or move the baggage in the required direction.

Such a baggage handling system and method reduces or minimises human interaction and intervention with the baggage and for tracking of baggage in accordance with various embodiments of the present invention.

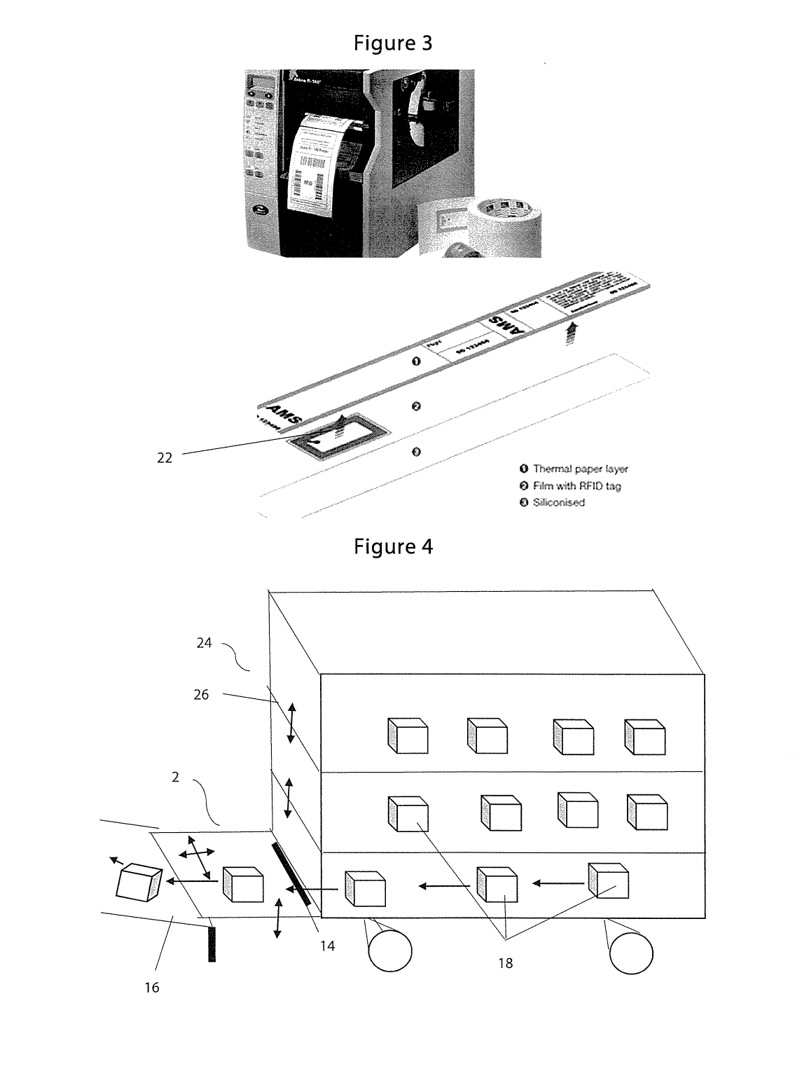

The baggage handling system comprises a baggage tracking system which uses RFID technology. At a typical check-in counter at an airport terminal, a baggage tag will be printed for each check-in baggage and will be adhered to the check-in baggage. The passenger details will be shown on the baggage tag and also stored in a bar code system. In the present baggage tracking system, a RFID sticker is built into each baggage tag resulting in a RFID tag 22 and the passenger information is stored in the RFID tag (see FIG. 3). Other information such as the details of the baggage like the weight and size can also be stored on the RFID tag 22. With the RFID tags, the location of the baggage will be trackable and traceable. After the baggage is tagged with the RFID tag 22, the baggage will then be sent to a holding area for loading onto a baggage cart designated for a particular flight.

Advantageously, the baggage handling system is therefore able to minimise human interaction with the baggage and minimises the possibility for human errors and consequently reducing the number of mishandled bags. The baggage handling system also enables the ease of tracing or tracking of baggage which helps to facilitate the reconciliation of a passenger and their baggage on or off an aircraft. This is advantageous as it facilities late retrieval of bags that are not allowed for loading to a flight.

In various embodiments the link platform further comprising an actuator capable of moving baggage from one location to another location based on information received from the baggage.

In various embodiments the actuator is a motor capable of driving the x-y conveying system in at least one direction.

In various embodiments an operator is aware of a direction that the baggage needs to be moved and the motor is programed to move the link platform in the required direction and any baggage placed on the link platform will be moved in the programmed direction. In various other embodiments, when a baggage 18 is loaded onto the link platform 2 and passes over the RFID transceiver 14, the transceiver 14 reads the RFID tag associated with the baggage that contains information about the required direction of the baggage. Such information requires the baggage to be moved in a certain direction. The motor is then directed to move the link platform, and as a consequence move the baggage in the required direction. To allow the programing of movement in at least 2 directions at least one of the x-y directions should be motorized and where all 4 directions and programmable both the x and y direction should be motorised. In various embodiments the rollers 4 in the link platform 2 are operated by two motors at the same time and one motor to control the X direction and another motor to control the Y direction to enable movement to any direction. However, in various embodiments suitable for the purpose of loading or unloading baggage only one motor for either X or Y direction movements are enough.

Referring to FIG. 4, in various embodiments when a baggage moves onto the link platform 2 and passes over the RFID transceiver 14, the transceiver 14 reads the RFID tag associated with the baggage 18 that contains information about the required direction of the baggage. Where the baggage is intended to move onto an adjoining conveyer 16 the motor drives the x-y conveying system in the direction towards the conveyer 16. In various other embodiments the actuator is a plunger capable of pushing a baggage off the link platform. In such an embodiment the y direction of the x-y conveyer system is provided by a mechanical force in this case the plunger moving the bag in a direction at an angle to the movement of the conveyer in the x direction. In such embodiments the link platform acts in a similar manner to a backwards and forwards conveyor. This allows the link platform described herein to form a conveyor system for sorting baggage in accordance with the intended location. The conveyor system comprises link platform that can be installed across two or more conveyors, the conveyors for conveying baggage to a respective desired location. The conveyor system also comprises a controller for reading RFID tags which are tagged to the baggage and an actuator, which can be in the form of a plunger.

When the link platform conveyor system is in use, baggage from the aircraft is transferred to the link platform of the conveyor system. When a bag enters the link platform, the controller of the conveyor system reads the RFID tag which is tagged to the bag and will direct the bag to the respective conveyor for conveying the bag to a desired location based on one or more details of the bag, such as the flight details.

For instance, as shown in FIG. 2, the link platform 2 is installed across two conveyors 16, one conveyor 16a for conveying baggage to another flight (for example, a connecting flight/flight transfer) and the other conveyor 16b for conveying baggage to a reclaim carousel for reclaiming. Upon the RFID transceiver 14 reading of the RFID tag of a bag, if the RFID tag reflects that the bag is to be conveyed to the reclaim carousel, the actuator 20 (in this example a plunger) will be activated and will push the bag 18 off the link platform 2 and onto the conveyor 16b for conveying baggage to a reclaim carousel. If the RFID tag reflects that the bag is to be conveyed to a connecting flight, the actuator 20 will not be activated and the bag will be dropped off onto the conveyor 16a for conveying baggage to another flight.

Advantageously, the conveyor system is able to sort or separate baggage to be conveyed to a first location from baggage to be conveyed to other locations as desired, such as a second location, a third location and so on. This reduces human interaction and intervention with the baggage hence minimising or eliminating mishandled bags due to human errors or oversight. Furthermore, it minimises or eliminates the possibility for unwanted “tampering” with the bags.

Advantageously, one or more conveyor systems can be installed across the desired number of conveyors to further reduce the total amount of time required for separating or sorting baggage to be conveyed to a first location from baggage to be conveyed to other locations as desired.

In various embodiments the link platform is attached to a moveable cart comprising;

a container for receiving and/or holding baggage, the container comprising a base and a top side connected by containment sides,

wherein the link platform extends at a at an angle from one of the containment sides, the x direction substantially parallel to the containment side from which it extends and the y direction at an angle to the x direction for movement of baggage into or out of the cart.

In various embodiments the cart is movable by being mounted on wheels for mobility but caterpillar treads or rollers or any other means that will allow the cart to move from one location to another location would suffice.

Referring to FIG. 4 in various embodiments the link platform 2 is attached to one of the sides of a cart 24, extending from the side at an angle so that it is forms a substantial continuation of the base of the container that allows the movement of baggage 18 to and from the container base. The angle between the side of the cart and the link platform when it is in use is preferably 80 to 105 degrees, or more preferably 85 to 100 degrees, or most preferably 90 to 95 degrees, or substantially, perpendicular or orthogonal.

In various embodiments the link platform is vertically moveable with respect to the containment side such that the link platform is capable of being raised or lowered to a plurality of locations between the top side and the base of the movable cart.

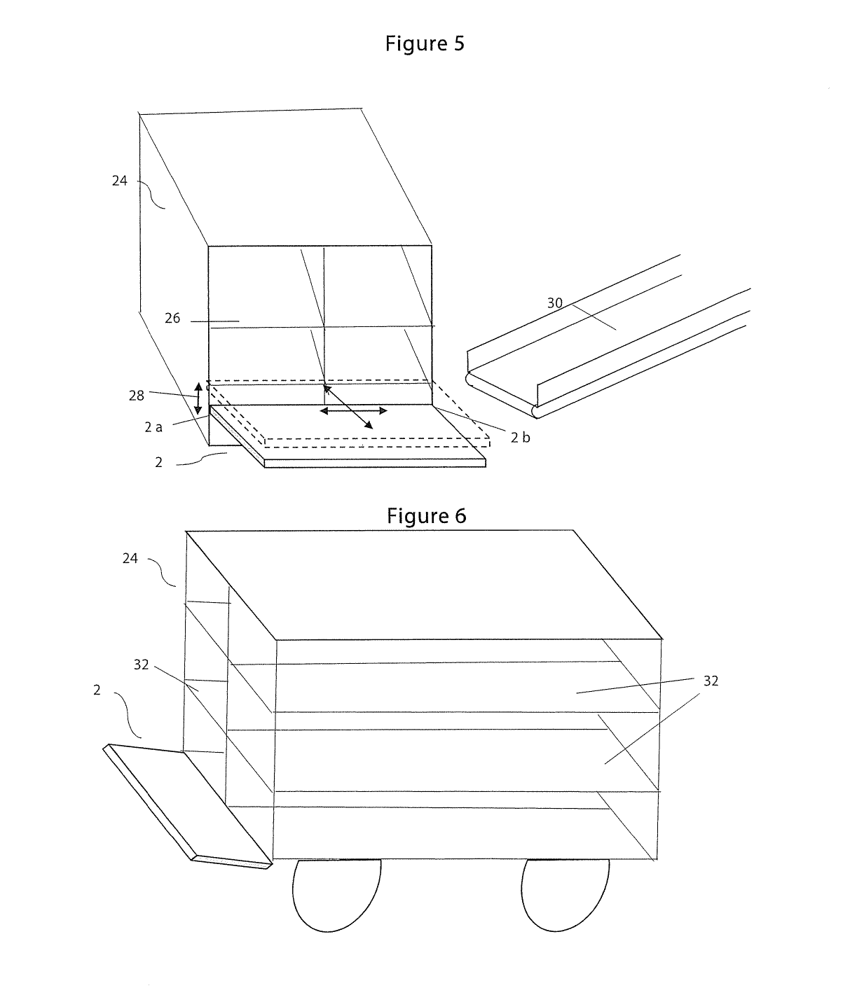

Referring to FIG. 5 in various embodiments the link platform 2 can be raised or lowered to different heights 28 in relation to the cart 24. In this way when certain zo pre-existing ramp 30 is used to move baggage to or from the aircraft cargo compartment and the height of the ramp is fixed the link platform 2 can be adjusted to conveniently connect the cart 24 to the ramp 30. The link platform 2 can then be raised or lowered 28 to load or unload the baggage 18 to or from the inside of the cart 26. The movement of the link platform 2 may be achieved by a rack and pinion system whereby the rack is mounted along the corner of the side attached to the link platform 2 from the base to adjacent the top side of the container and the pinion mounted on either corner of the link platform 2a and 2b. The vertically movability of the link platform 2 with respect to the containment side may be achieved by any other method known in the art that allows the link platform 2 to be raised or lowered to a plurality of locations between the top side and the base of the movable cart 24.

In various embodiments the container of the cart comprises a plurality of shelves for receiving and/or holding baggage.

Referring to FIG. 6, in various embodiments the container of the cart 24 comprises a plurality of shelves or racks 32 for receiving and holding baggage or items of the like. The racks of the cart define the number of levels of the cart and each level can be of a different height. In the Example of FIG. 6 there are two selves 32 which effectively form 3 levels, including the space between the base and the first shelf the space between the first and second shelf, and the space between the second shelf and the top side.

In various embodiments one or more of the plurality of shelves comprises a conveyer capable of moving baggage along the shelf.

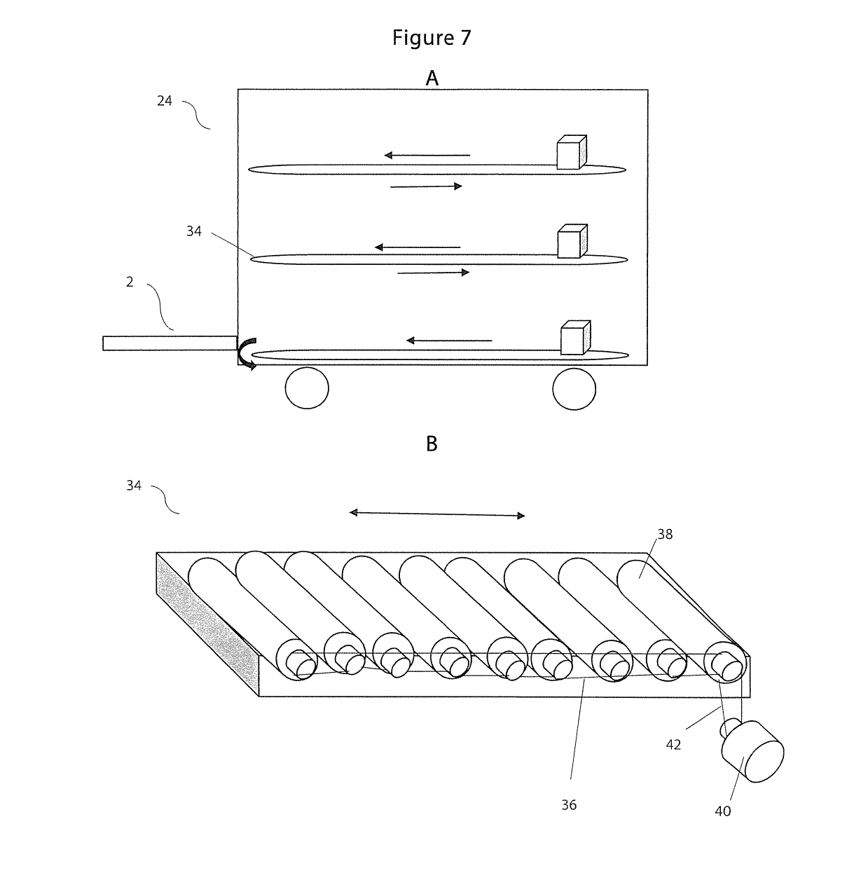

Referring to FIG. 7, in various embodiments the shelves are in the form of a conveyer 34. The conveyer 34 may be any conveyer known in the art for example in the form of a belt or chain 36 over rollers 38 such as that depicted in FIG. 7B. The belt or chain 36 is then coupled to a belt coupling or a gear coupling 42 preferably driven by a motor such as a torque motor 40. In use this means a baggage is able to be moved into, out from and within the container to efficiently transferring from one location to another location

In various embodiments one or more of the plurality of shelves is vertically moveable with respect to the containment side such that the one or more moveable shelves is capable of being raised or lowered to a plurality of locations between the top side and the base.

In various embodiments only 1 shelf is vertically moveable with respect to the containment side such that the shelf is capable of being raised or lowered to a plurality of locations between the top side and the base. This provides an advantage of accommodating larger sized baggage. In these embodiments one shelf can be made movable up and down, where the other selves are fixed in place.

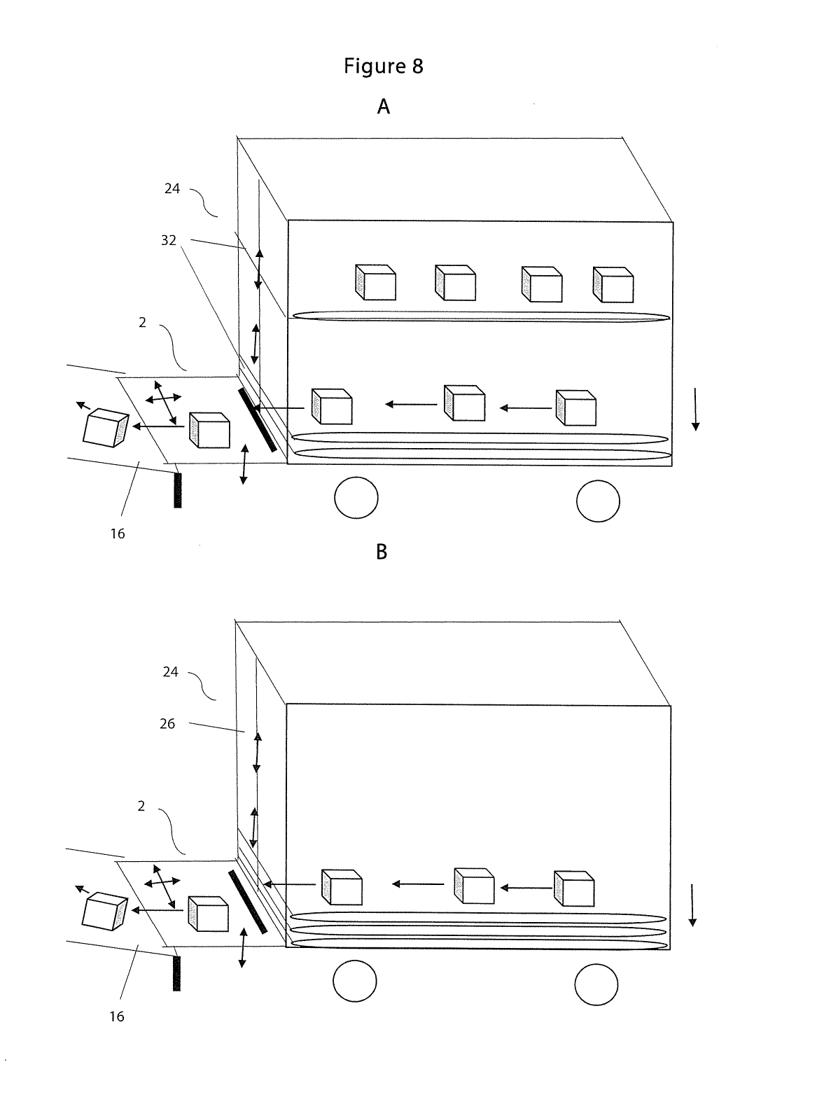

Referring to FIG. 8, in various embodiments the racks of the cart are movable along the height of the cart. In these embodiments, the cart comprises three racks, two of which are moveable racks, defining three levels for receiving and holding baggage. In these embodiments, the bottom rack which is the rack at the base of the cart is not required to move along the height of the cart. However, the lowest rack can also be made movable along the height of the cart if required. The top rack, which is the rack at the top of the cart, and the middle rack, which is between the top rack and the bottom rack, are movable along the height of the cart. In the embodiments as shown in FIG. 11, there are six conveyors 34 and each of the conveyors can run separately from one another.

Referring to FIG. 8C, in various embodiments a winch system 44 is applied to operate or enable the movement of the shelves 32. The shelves are attached to a rod 48 that forms the frame of the container. The winch system is either lowered or raised and the shelves move over the rod 48 guided by a guide bush bearing 46. Advantageously, a winch system 44 is simple, small and cost effective as compared to other systems such a rack pinion, linear actuator and a ball screw jack system. It would be appreciated that other systems similar to a winch system may be used to operate the racks/shelves.

In various embodiments the link platform is capable of rotating about a location that it connects to the containment side to form a side door of the cart.

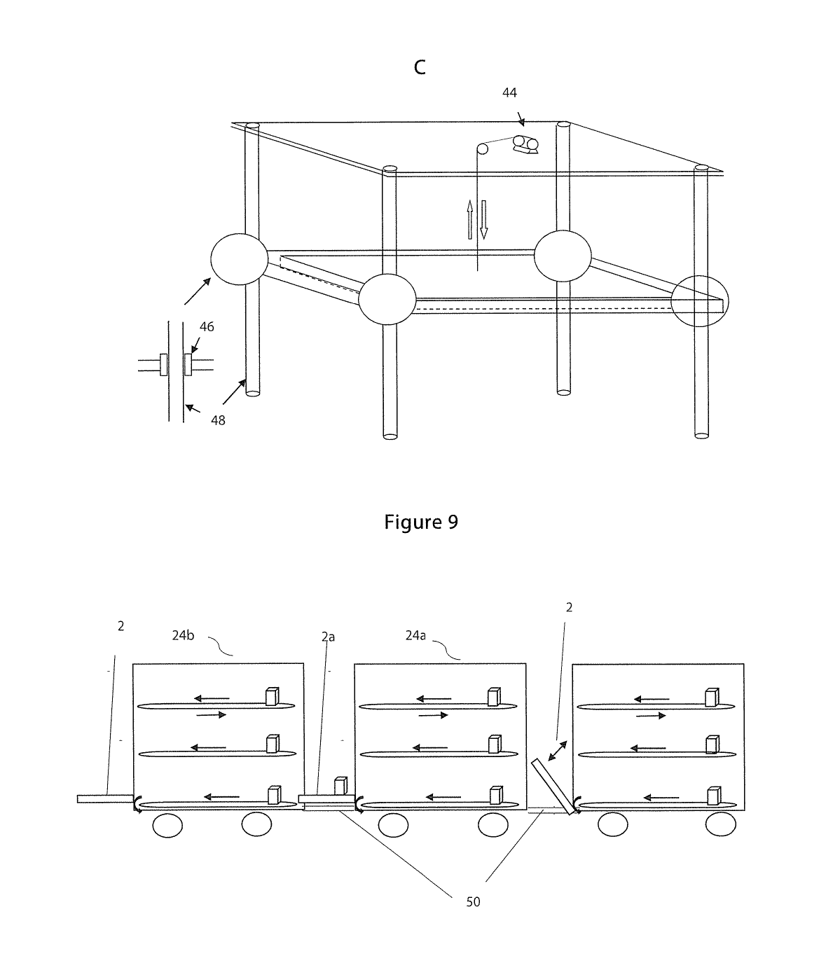

Referring to FIG. 9, in various embodiments a plurality of baggage carts 24 are linked together via a tow link 50 and the link platform is placed over the tow link 50 or in this example the link platform is pivotally connected to the containment side to form a side door of the cart 24 and the link platform/side door 2 is lowered over the tow link 50 allowing baggage to move from one cart 24a to another cart 24b over the link platform 2a.

In various embodiments at least one of the containment sides is capable of being opened and closed to form a side door.

In various embodiments the container further comprises a partition dividing the container into a first housing and a second housing.

Referring to FIG. 10, in various embodiments the side door is in the form of a roller door 52 supported by a solid frame 54 around the containment side to support the container when the door is open while allowing full access to all the shelves. Other doors known in the art may also be used as long as they do not obstruct the movement of baggage into and out of the cart 24. At least one side door may include 2 side doors, 3 side doors or preferably 4 side doors to provide easy access to the cart from all sides and facilitate loading the cart.

Another aspect of the invention relates to a moveable cart comprising; a container for receiving and/or holding baggage, the container comprising a base and a top side connected by containment sides, and a link platform comprising an x-y conveying system capable of movement backwards or forwards in an x direction and capable of movement backwards or forwards in a y direction, wherein the link platform extends at an angle from one of the containment sides, the x direction substantially parallel to the containment side from which it extends and the y direction at an angle to the x direction for movement of baggage into or out of the cart.

An aspect of the present invention, there is provided a baggage cart for transferring baggage from one location to another, such as to and off the aircraft and to and from the terminal building whilst reducing or minimising human interaction and intervention with the baggage and at the same time being able to track the baggage. Advantageously, the cart has self-aligning capabilities, self-levelling capabilities, and identification capabilities. The cart is also capable of collecting baggage details such as the size and weight of a bag, the name of the traveller, flight details, and any other details as desired.

A baggage cart is described hereinafter in accordance with an aspect of an embodiment of the present invention. The baggage cart is used for transferring baggage from one location to another, such as to and off the aircraft and to and from the terminal building whilst reducing or minimising human interaction and intervention with the baggage and at the same time being able to track the baggage.

Referring to FIGS. 4 to 10, various embodiments of the cart are described. In various embodiments the baggage cart 24 (hereinafter known as “cart”) or trolley comprises a container or receptacle 26 for receiving and holding baggage or items of the like 18. The container is defined by a base, a top side and four sides, in which the base is connected to the top side via the four sides.

In various embodiments the link platform is vertically moveable with respect to the containment side such that the link platform is capable of being raised or lowered to a plurality of locations between the top side and the base of the movable cart.

In various embodiments the container of the cart comprises a plurality of shelves for receiving and/or holding baggage. The container of the cart comprises a plurality of shelves or racks for receiving and holding baggage or items of the like. The racks of the cart define the number of levels of the cart and each level can be of a different height.

In various embodiments one or more of the plurality of shelves comprises a conveyer capable of moving baggage along the shelf.

In reference to FIG. 7, in various embodiments the cart further comprises a conveyor on each of the racks for conveying or moving baggage from one end of the cart to the other end of the cart. The conveyor can be in the form of a belt or rollers, such as ball rollers, as shown in FIGS. 7, or the like. The conveyors or rollers are preferably operated by direct current (“DC”) power. In various embodiments the conveyer shelves include conveyers that are capable of move backwards or forward 34a or conveyers that are capable of moving in x-y directions 34b as depicted in the example in FIG. 11 and described herein.

In various embodiments one or more of the plurality of shelves is vertically moveable with respect to the containment side such that the one or more is moveable shelves is capable of being raised or lowered to a plurality of locations between the top side and the base.

In various embodiments the racks of the cart are movable along the height of the cart as shown in FIG. 8A-80. In an embodiment, the cart comprises three racks, two of which are moveable racks, defining three levels for receiving and holding baggage. In this embodiment, the bottom rack which is the rack at the base of the cart is not required to move along the height of the cart. However, the lowest rack can also be made movable along the height of the cart if required. The top rack, which is the rack at the top of the cart, and the middle rack, which is between the top rack and the bottom rack, are movable along the height of the cart. In the embodiments as shown in FIGS. 10 and 11, there are six conveyors and each of the conveyors can run separately from one another.

In various embodiments the link platform is capable of rotating about a location that it connects to the containment side to form a side door of the cart as discussed herein.

In various embodiments at least one of the containment sides is capable of being opened and closed to form a side door as discussed herein.

At least one of the sides can function as a door that can be opened for baggage to enter the cart or closed when the cart is being moved from one location to another as discussed herein.

In various embodiments the moveable cart further comprises a global positioning system capable of aligning and linking the moveable cart with a second moveable cart such that the link platform of the first and second movable cart are parallel with the container of the first moveable cart therebetween.

In reference to FIGS. 9 and 12-14, in various embodiments the carts 24 self-aligning global positioning system aligns a plurality of carts whereby each cart is linked by a link platform 2.

In various embodiments the container further comprises a partition dividing the container into a first housing and a second housing, Referring to FIGS. 10 and 11, the container of such embodiments comprises a partition 53 there within which divides each rack into two portions, a first portion and a second portion. The first portion can be in the form of a front housing 26a and the second portion can be in the form of a backward housing 26b. The partition 53 may or may not comprise a through-hole.

In various embodiments the link platform comprises a RFID transceiver as described above. In various embodiments the cart further comprises a radio frequency identification system capable of receiving, storing or transmitting radio frequency. In reference to FIG. 10, in various embodiments the cart further comprises a controller, a Radio Frequency Identification (“RFID”) system which has a RFID transceiver 55 which can act as a transmitter and receiver, and a control panel (not shown). The RFID transceiver 55 can transmit and receive via 4 and/or 5G WIFI. Upon activation of the control panel, the baggage from the cart will be loaded onto a ramp leading to the cargo storage area of an aircraft via the link platform 2. Prior to the activation of the control panel, the cart is aligned with the ramp via the link platform to facilitate the moving of the baggage from the cart up onto the ramp and then into the plane cargo storage area. In various embodiments the RFID transceiver 14 on the link platform interacts with the RFID transceiver 55 on the cart transmitting and receiving information therebetween to coordinate movement of the baggage without requiring people. Suitable logical electronic communication and commands can be programmed into the RFID system as would be known by a person skilled in the art.

In various embodiments the cart comprises the controller for reading RFID tags which are tagged to the baggage. When a bag enters or leaves the cart, the RFID system will register the bag and send back signals through the RFID transceiver to a main baggage sorting area main computer or controller housed at a baggage terminal.

Another aspect of the invention relates to a method for transferring baggage from one location to another location comprising moving a baggage on a link platform comprising an x-y conveying system; moving the baggage on the link platform in one of several directions comprising backwards or forwards in an x direction; or backwards or forwards in a y direction.

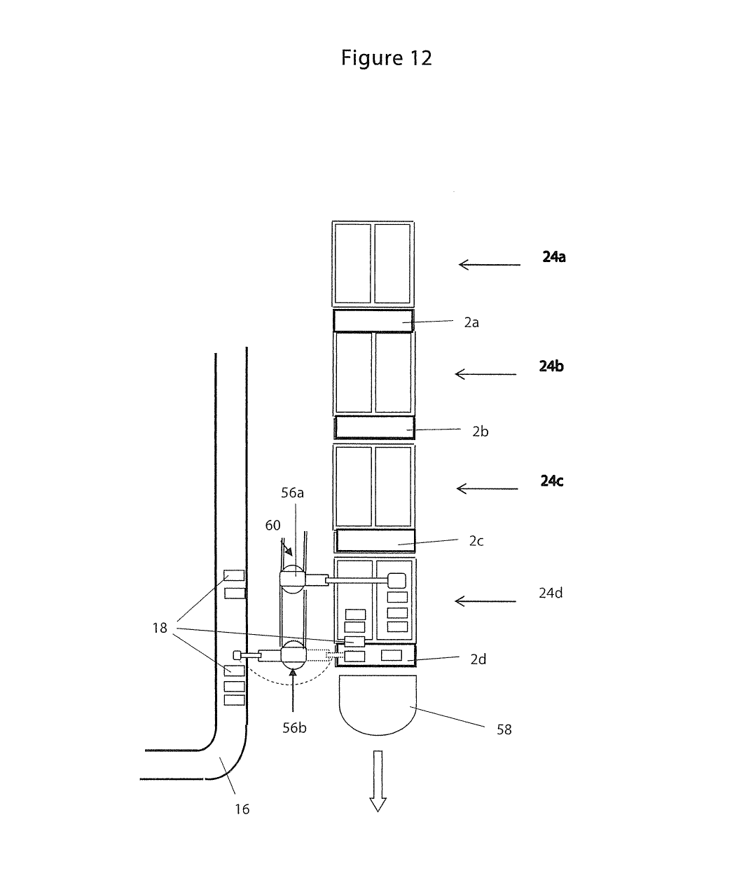

In various embodiments the baggage may be placed on the link platform by a person but preferably the baggage is moved onto the link platform via a conveyer such as an aircraft ramp when an aircraft is being unloaded or from inside a baggage cart. In reference to FIGS. 12 and 15, in various embodiments the baggage may be placed on the link platform by an electronic mechanical robot arm 56. Some robotic arms cannot be used to load a baggage cart because the height of the robot arm 33a would need to be less than the height of the shelf 33b, in order to put the baggage into the cart. However, the use of the link platform with the cart means that there is no restriction on the size of the robot arm 56. Once the link platform is loaded with the baggage 18, the baggage can be moved into the cart either in an x direction as required or in a y direction or in embodiments where the link platform is vertically moveable with respect to the containment side of the cart, the baggage on the link platform is capable of being raised or lowered to a different shelf to enter the cart.

In various other embodiments whereby the size of the robotic arm 56 is less than the height of the shelf it is possible that the baggage 18 is picked up by the robotic arm 56 and placed directly into the cart 24 all the way across to the distant side of the cart from the robotic arm 56. This will allow two or more robotic arms 56 to load the cart 24 simultaneously. In reference to FIG. 12, in various embodiments a first robotic arm 56a that has a size less than the space of the shelf is deployed to place baggage 18 directly into the cart 24, on one shelf level and a second robotic arm 56b that can be of any size, is deployed to place baggage on the link platform that is aligned with a shelf above or below the shelf being packed by the first robotic arm 56a. In this way two shelves can be packed simultaneously with two robotic arms 56a-b. In addition to the link platform reducing the use of manpower, use of electronic mechanical robot arms 56 would also have the advantage of minimising using personnel which may increase productivity, minimize work injuries and/or minimize mistakes due to human error.

In various embodiments the robotic arm may comprises a RFID transceiver as described above. In such embodiments the robotic arm 56 receives the signal from the RFID tag 22 associated with a baggage. Based on the information the robot arm 56 can be programmed to pick up a relevant baggage 18 and place the baggage 18 in the relevant location within the cart. This will allow ideal packing density within the cart and allow for quick location and retrieval of any one particular baggage. The location information of each baggage within the cart may be recorded to form a map of the location of each baggage within the cart.

In various other embodiments where the baggage may be placed on the link platform by a person in an embodiment the person wears a semi-robotic lumbar support with mechanical arms reducing the risk of work place injuries.

In accordance with another aspect of the present invention, there is provided a baggage handling system for reducing or minimising human interaction and intervention with the baggage and for tracking of the baggage.

In accordance with another aspect of the present invention, there is provided a baggage handling method for reducing or minimising human interaction and intervention with the baggage and for tracking of the baggage.

In various embodiments the baggage is moved to or from the link platform into or out from a cart comprising a container comprising a base and a top side connected by containment sides.

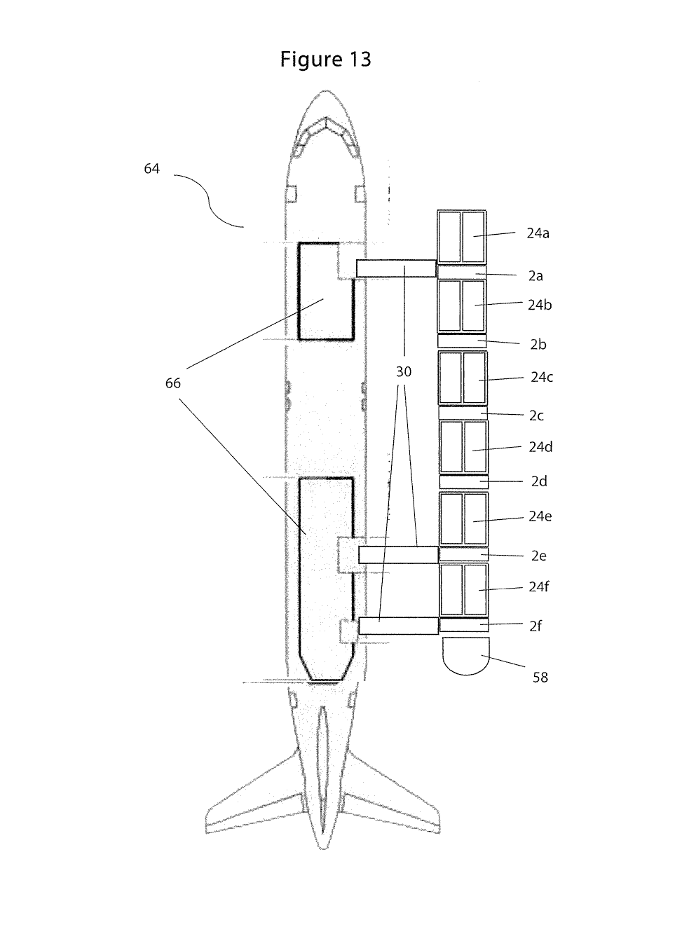

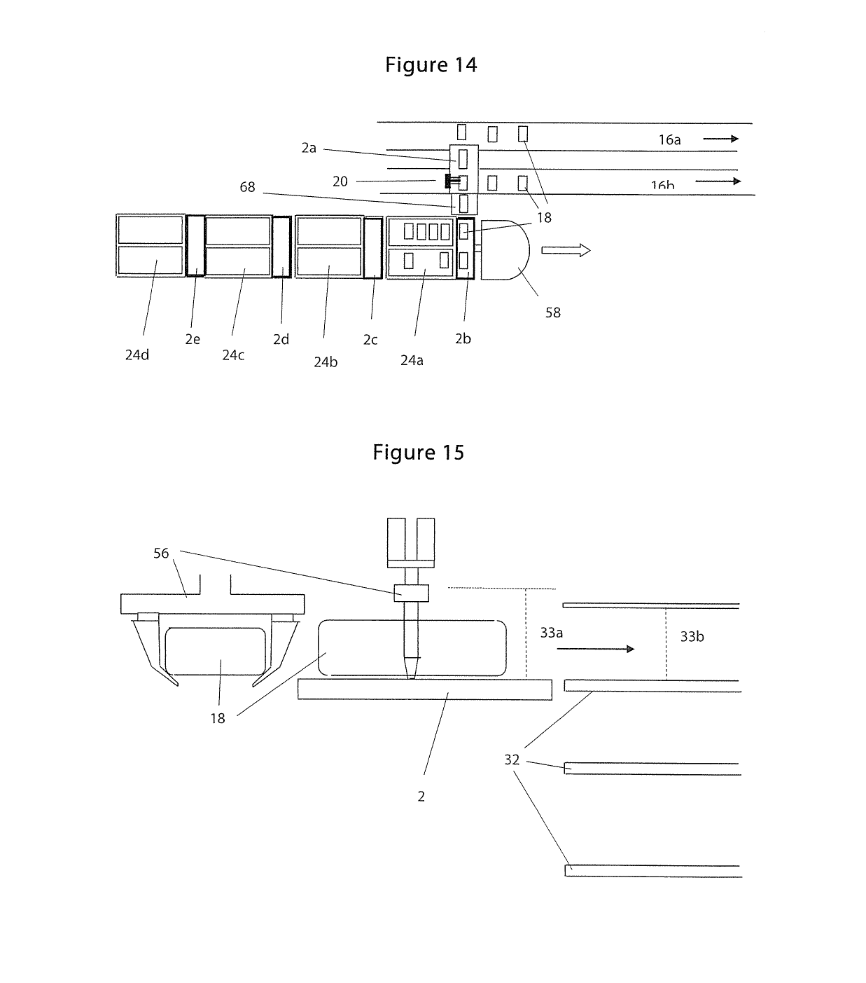

In reference to FIG. 4, in various embodiments the link platform is attached to a moveable cart such as a baggage cart. In this example the baggage 18 is moving out from the cart 24 to the link platform where it is moved onto another conveyer 16. In reference to FIG. 14, in various embodiments the baggage 18 is moved out from the cart 24 to the link platform 2b where it is moved onto another link platform 2a and transferred to a conveyer 16. In reference to FIG. 13, in various embodiments the baggage 18 is moving from the ramp 30 to the link platform 2a, 2e or 2f and is transferred into the carts 24a-24f.

In various embodiments the baggage in the cart is moved on a conveyer along the inside of the cart.

In various embodiments a conveyer is used to assist movement of baggage and the like within the cart. This has the advantage of making it easier to load a cart as the baggage can be moved to the back and loaded from just one location.

In various embodiments the baggage in the cart is moved on a conveyer through the cart.

In various embodiments a plurality of carts are aligned with a link platform between each cart permitting a baggage to move along a conveyer in one cart straight through to the attached link platform on the other side of the cart and then enter a second cart. Such a system has the advantage of making it easier to load a plurality of carts as the baggage can be moved from one cart to another.

In various embodiments the baggage is moved vertically with respect to the containment side on the link platform before it enters the cart or on a shelf when inside the cart.

In various embodiments the link platform is moveable with respect to the side of the cart, In this way the link platform of such embodiments may be raised or lowered in relation to the cart. In reference to FIG. 5, in various embodiments the link platform 2 can be placed at the level of an aircraft ramp 30 and a number of bags are moved or loaded onto the link platform 2 from the ramp 30. When the link platform holds its maximum number of bags, defined by the link platform's space or weight load constrains, the link platform 2 is raised or lowered to a position at the side of the cart 24 whereby the baggage can be moved from the link platform 2 into the cart 24. In these embodiments the baggage moves off the ramp 30 onto the link platform 2 in an x direction and off the link platform 2 into the cart 24 in a y direction. The multidirectional movement capabilities of the link platform provides the missing link to minimise the effort of transferring baggage in more than one direction.

In various embodiments the cart has one or more shelves that are moveable with respect to the side of the cart. In this way the shelves of such embodiments may be raised or lowered in relation to the cart. In reference to FIG. 8, in various embodiments the cart first offloads a lowest shelf on the base of the container, then the second shelf is lowered, as the example in FIG. 8A shows, and the contents of the second shelf are offloaded, and finally the top shelf is lowered, as the example in FIG. 8B shows, and the contents of the top shelf are offloaded.

In various embodiments a radio frequency identification system on the link platform receives information from a radio frequency tag attached to the baggage.

In various embodiments the information is transmitted to a control station.

In various embodiments the information indicates the intended direction of the baggage and the x-y conveyer system moves the baggage in the intended direction.

In various embodiments the information indicates the intended direction of the baggage and an actuator moves the baggage in that direction.

The radio frequency identification system comprises a baggage tracking system which uses RFID technology. At a typical check-in counter at an airport terminal, a baggage tag will be printed for each check-in baggage and will be adhered to the check-in baggage. The passenger details will be shown on the baggage tag and also stored in a bar code system. In the present radio frequency identification tracking system, a RFID sticker is built into each baggage tag resulting in a RFID tag and the passenger information is stored in the RFID tag (FIG. 3). Other information such as the details of the baggage like the weight and size can also be stored on the RFID tag. With the RFID tags, the location of the baggage will be trackable and traceable. After the baggage is tagged with the RFID tags, the baggage will then be sent to a holding area for loading onto a baggage cart designated for a particular flight.

In various embodiments the link platform comprises an RFID transceiver able to receive information from the RFID tag. This information can be used to direct the movement of any baggage that enters the link platform and/or the information may be transmitted to a control station that may be on the fink platform or on a cart or at a remote location within the airport terminal. In various embodiments the link platform is attached to a cart and the cart may further comprises a radio frequency identification system capable of receiving, storing or transmitting radio frequency. The RFID transceiver of the cart can transmit and receive via 4 and/or 5G WIFI. In various embodiments the RFID transceiver on the link platform interacts with the RFID transceiver on the cart transmitting and receiving information therebetween to coordinate movement of the baggage without requiring people. Similar exchange of information may be transmitted to a control station within the terminal. Suitable logical electronic communication and commands can be programmed into the RFID system as would be known by a person skilled in the art.

In various embodiments the baggage is moved from the link platform to a baggage conveyor.

In reference to FIGS. 2 and 14, in various embodiments the link platform 2, or 2a is located over two conveyer two conveyors 16, one conveyor 16a for conveying baggage to another flight (for example, a connecting flight/flight transfer) and the other conveyor 16b for conveying baggage to a reclaim carousel for reclaiming. In reference to FIG. 14, in various embodiments the link platform 2a has a telescoping extension 68 at the side adjacent the RFID transceiver 14 that is extended therefrom to form a connection between a link platform 2a located over the conveyers and a link platform 2b attached to a cart 24a. The baggage 18 moves out of the cart in any of the methods discussed herein and onto the link platform 2b attached to a cart 24a. It then moves off the link platform on to the telescoping extension 68 and onto the link platform 2a located over the conveyers. Upon the RFID transceiver 14 reading of the RFID tag of a bag, if the RFID tag reflects that the bag is to be conveyed to the reclaim carousel, the actuator 20 (in this example a plunger) will be activated and will push the bag 18 off the link platform 2 and onto the conveyor 16b for conveying baggage to a reclaim carousel. If the RFID tag reflects that the bag is to be conveyed to a connecting flight, the actuator 20 will not be activated and the bag will be dropped off onto the conveyor 16a for conveying baggage to another flight. In various other embodiments the actuator is a motor that drives the movement of the link platform in a y direction upon receiving a suitable commend in relation to the information received from the RFID tag or drives the movement of the link platform in an x direction upon receiving a different suitable commend in relation to the information received from the RFID tag.

Example for Loading an Aircraft

With reference to FIG. 13, when an aircraft is to be loaded a cart 24 containing baggage, more often a plurality of carts 24a-24f is driven to the aeroplane. Preferably the cart or carts are coupled to a tractor 58 and the carts are located at a position convenient for loading the baggage to the ramp 30, in the front housing, the conveyor on the bottom rack will be activated first to facilitate movement of the baggage from the bottom rack onto the ramp. Once all the baggage on the bottom rack has been loaded onto the ramp 30, the middle rack will move downwards toward the bottom rack and the conveyor of the middle rack will be activated to facilitate movement of the baggage from the middle rack onto the ramp. After all the baggage from the middle rack is loaded onto the ramp, the top rack will move downwards along the height of the cart toward the bottom rack and the conveyor of the top rack will be activated to facilitate movement of the baggage from the top rack onto the ramp for delivery into the cargo storage area of the aircraft.

After all the baggage from the front housing has been loaded, the x-y conveyer system allows the baggage in the backward housing to be unloaded from the second portion of the cart and onto the ramp. The process of unloading is similar to the steps as described above for the first portion. Existing airport ramps (width wise) are approximately the size of one baggage, which is the reason why the ramp would have to be shifted from the front housing to the backward housing for unloading of baggage form the backward housing if it was not for the x-y conveyer system. In another embodiment where the cart comprises more racks, the additional racks will similarly be moveable along the height of the cart and are operated in the same manner as described above for the middle and top racks.

Example for Unloading an Aircraft

For the reverse cycle in which baggage are now being unloaded from the aircraft or terminal building onto the racks of the cart, the baggage will be loaded on the top rack first followed by the middle rack and then the bottom rack. Once the top rack is loaded, the top rack will move along the height of the cart toward the top of the cart. This is followed by the loading of baggage onto the middle rack and the rack will move upwards to a predetermined middle level and finally the bottom rack will then be loaded with baggage.

In another embodiment of the baggage cart, after all the baggage has been unloaded from the front housing onto a ramp or any connecting means, there is no need to move the ramp or connecting means to align with the backward housing for unloading of the baggage in the backward housing. The baggage on the bottom rack of the backward housing can be moved to the bottom rack of the front housing for loading onto the ramp or connecting means. Once all the baggage on the bottom rack of the backward housing has been moved, the middle rack of the backward housing moves downwards to the bottom rack and the baggage on the middle rack will be moved to the bottom rack of the front housing for loading onto the ramp or connecting means. Once that is completed, the top rack of the backward housing similarly moves down towards the bottom rack and all the baggage on the top rack will be moved to the bottom rack of the front housing for loading onto the ramp or connecting means (see FIGS. 9). In this way baggage can be transferred from a plurality of carts to an aircraft or a terminal without having to move the carts or require personnel to strain themselves moving baggage greater distances.

For the reverse cycle in which baggage are now being loaded from the aircraft or terminal building onto the racks of the cart, the steps outlined above will be reversed.

Advantageously, the cart has self-aligning capabilities, self-levelling capabilities, and identification capabilities. The cart is also capable of collecting baggage details such as the size and weight of a bag, the name of the traveller, flight details, and any other details as desired.

Advantageously, the cart is self-powered, such as powered by a battery and/or a solar photovoltaic panel. The link platform can also be used as part of a baggage handling system, such as CLAIRS™ (Cybernet, Logistic, Automated, Intelligent Robotic System) or used on its own. The link platform can be attached to a cart. The cart can also be coupled to other carts with link platforms using Global Positioning System (“GPS”) and/or a software, and can be towed by an autonomous airport baggage tow truck.

The baggage cart is therefore able to minimise human interaction with the baggage and minimises the possibility for human errors and consequently reducing the number of mishandled bags. The cart also enables the ease of tracing or tracking of baggage which helps to facilitate the reconciliation of a passenger and their baggage on or off an aircraft. This is advantageous as it facilities late retrieval of bags that are not allowed for loading to a flight.

An example of the cart's self-aligning capabilities is described as follows. Referring to FIG. 9, or 12-14, there is shown a plurality of baggage carts 24, namely three baggage carts, being lined up for transfer of baggage from one location to another in an automatic fashion. Each cart 24 can automatically align itself to another cart by using systems including Programmable Logic Controller (PLC) based alignment and positioning systems, GPS and/or a software, and each cart can be linked to another cart by means of a tow link 50.

Advantageously, in various embodiments each cart comprises a side door that can be lowered to act as a link platform 2, as described herein, that links one cart to the next cart. This platform can be used to transfer baggage from one cart to another cart without having to move or re-align the carts. The fink platform 2 can also be used to connect the cart to a ramp for transfer of baggage from the cart to the ramp. As such, there is no need to remove the first cart after the baggage has been transferred, align the second cart to the ramp for transfer of baggage from the second cart to the ramp, remove the second cart after transfer is completed, followed by aligning the third cart for transfer of baggage from the third cart to the ramp. This saves time and hence the total time required to transfer all the baggage from each of the carts to the ramp is reduced as compared to the time taken for conventional baggage carts to transfer baggage from the carts to the ramp.

In another embodiment of the invention, the baggage handling system comprises the baggage tracking system and the baggage cart as described above. As described above, the RFID transceiver of the link platform is for reading RFID tags which are tagged to the baggage. When a bag is loaded onto the link platform, the information on the RFID tag of the bag is being read by the RFID transceiver. Advantageously, the RFID tag not only allows the tracking and tracing of the bag, it can also be used to activate the baggage system including the x-y conveyer and other features of the baggage cart as discussed herein.

There is also described hereinafter a conveyor system for sorting baggage in accordance with an aspect of the present invention. The conveyor system comprises a link platform as disclosed herein that can be installed across two or more conveyors, the conveyors for conveying baggage to a respective desired location. The conveyor system also comprises a controller for reading RFID tags which are tagged to the baggage and an actuator, which can be in the form of a plunger.

When the conveyor system is in use, baggage from the aircraft is transferred to the link platform of the conveyor system by means of a cart as described above or any baggage cart. When a bag enters the link platform, the controller of the conveyor system reads the RFID tag which is tagged to the bag and will direct the bag to the respective conveyor for conveying the bag to a desired location based on one or more details of the bag, such as the flight details.

For instance, as shown in FIG. 2, the link platform is installed across two conveyors, one conveyor for conveying baggage to another flight (for example, a connecting flight/ flight transfer) and the other conveyor for conveying baggage to a reclaim carousel for reclaiming. Upon reading of the RFID tag of a bag, if the RFID tag reflects that the bag is to be conveyed to the reclaim carousel, the actuator will be activated and will push the bag off the link platform and onto the conveyor for conveying baggage to a reclaim carousel. If the RFID tag reflects that the bag is to be conveyed to a connecting flight, the actuator will not be activated and the bag will be dropped off onto the conveyor for conveying baggage to another flight.

Advantageously, the conveyor system is able to sort or separate baggage to be conveyed to a first location from baggage to be conveyed to other locations as desired, such as a second location, a third location and so on. This reduces human interaction and intervention with the baggage hence minimising or eliminating mishandled bags due to human errors or oversight. Furthermore, it minimises or eliminates the possibility for unwanted “tampering” with the bags.

Advantageously, one or more conveyor systems can be installed across the desired number of conveyors to further reduce the total amount of time required for separating or sorting baggage to be conveyed to a first location from baggage to be conveyed to other locations as desired.

The conveyor system may be part of a baggage handling system such as CLAIRS™ (Cybernet, Logistic, Automated, Intelligent Robotic System) or used on its own.

Although the foregoing invention has been described in some detail by way of illustration and example, and with regard to one or more embodiments, for the purposes of clarity of understanding, it is readily apparent to those of ordinary skill in the art in light of the teachings of this invention that certain changes, variations and modifications may be made thereto without departing from the spirit or scope of the invention as described in the appended claims.

It would be further appreciated that although the invention covers individual embodiments, it also includes combinations of the embodiments discussed. For example, the features described in one embodiment is not being mutually exclusive to a feature described in another embodiment, and may be combined to form yet further embodiments of the invention.

1. A link platform for transferring baggage from one location to another location comprising an x-y conveying system capable of movement backwards or forwards in an x direction and capable of movement backwards or forwards in a y direction wherein the y direction is at an angle to the x direction.

2. The link platform according to claim 1, further comprising a radio frequency identification system capable of receiving, storing or transmitting radio frequency.

3. The link platform according to claim 1 or 2, further comprising an actuator capable of moving baggage from one location to another location based on information received from the baggage.

4. The link platform according to claim 3, wherein the actuator is a motor capable of driving the x-y conveying system in at least one direction.

5. The link platform according to claim 3, wherein the actuator is a plunger capable of pushing a baggage off the link platform.

6. The link platform according to any one of the preceding claims, wherein the link platform is attached to a moveable cart comprising;
a container for receiving and/or holding baggage, the container comprising a base and a top side connected by containment sides,
wherein the link platform extends at an angle from one of the containment sides, the x direction substantially parallel to the containment side from which it extends and the y direction substantially perpendicular to the containment side from which it extends for movement of baggage into or out of the cart.

7. The link platform according to claim 6, wherein the link platform is vertically moveable with respect to the containment side such that the link platform is capable of being raised or lowered to a plurality of locations between the top side and the base of the movable cart.

8. The link platform according to claim 6 or 7, wherein the container of the cart comprises a plurality of shelves for receiving and/or holding baggage.

9. The link platform according to claim 8, wherein one or more of the plurality of shelves comprises a conveyer capable of moving baggage along the self.

10. The link platform according to claim 8 or 9, wherein one or more of the plurality of shelves is vertically moveable with respect to the containment side such that the one or more moveable shelves is capable of being raised or lowered to a plurality of locations between the top side and the base.

11. The link platform according to any one of claims 6-10, wherein the link platform is capable of rotating about a location that it connects to the containment side to form a side door of the cart.

12. The link platform according to any one of claims 6-10, wherein at least one of the containment sides is capable of being opened and closed to form a side door.

13. The link platform according to any one of claims 6-12, wherein the container further comprises a partition dividing the container into a first housing and a second housing.

14. A moveable cart comprising;
a container for receiving and/or holding baggage, the container comprising a base and a top side connected by containment sides, and a link platform comprising an x-y conveying system capable of movement backwards or forwards in an x direction and capable of movement backwards or forwards in a y direction, wherein the link platform extends at an angle from one of the containment sides, the x direction substantially parallel to the containment side from which it extends and the y direction at an angle to the x direction for movement of baggage into or out of the cart.

15. The moveable cart according to claim 14, wherein the link platform is vertically moveable with respect to the containment side such that the link platform is capable of being raised or lowered to a plurality of locations between the top side and the base of the movable cart.

16. The moveable cart according to claim 14 or 15, wherein the container of the cart comprises a plurality of shelves for receiving and/or holding baggage.

17. The moveable cart according to claim 16, wherein one or more of the plurality of shelves comprises a conveyer capable of moving baggage along the self.

18. The moveable cart according to claim 16 or 17, wherein one or more of the plurality of shelves is vertically moveable with respect to the containment side such that the one or more moveable shelves is capable of being raised or lowered to a plurality of locations between the top side and the base.

19. The moveable cart according to any one of claims 14-18, wherein the link platform is capable of rotating about a location that it connects to the containment side to form a side door of the cart.

20. The moveable cart according to any one of claims 14-18, wherein at least one of the containment sides is capable of being opened and closed to form a side door.

21. The moveable cart according to any one of claims 14-20, wherein the container further comprises a partition dividing the container into a first housing and a second housing.

22. The moveable cart according to any one of claims 14-21, further comprising a radio frequency identification system capable of receiving, storing or transmitting radio frequency.

23. The moveable cart according to any one of claims 14-22, further comprising a global positioning system capable of aligning and linking the moveable cart with a second moveable cart according to any one of claims 13-21 such that the link platform of the first and second movable cart are parallel with the container of the first moveable cart therebetween.

24. A method for transferring baggage from one location to another location comprising moving a baggage on a link platform comprising an x-y conveying system; moving the baggage on the link platform in one of several directions comprising backwards or forwards in an x direction; or backwards or forwards in a y direction.

25. The method according to claim 24, wherein the baggage is moved to or from the link platform into or out from a cart comprising a container comprising a base and a top side connected by containment sides.

26. The method according to claim 25, wherein the baggage in the cart is moved on a conveyer along the inside of the cart.

27. The method according to claim 25, wherein the baggage in the cart is moved on a conveyer through the cart.

28. The method according to claim 25 or 26, wherein the baggage is moved vertically with respect to the containment side on the link platform before it enters the cart or on a shelf when inside the cart.

29. The method according to claim 24, wherein a radio frequency identification system on the link platform receives information from a radio frequency tag attached to the baggage.

30. The method according to claim 29, wherein the information is transmitted to a control station.

31. The method according to claim 29, wherein the information indicates the intended direction of the baggage and the x-y conveyer system moves the baggage in the intended direction.

32. The method according to claim 29, wherein the information indicates the intended direction of the baggage and an actuator moves the baggage in that direction.

33. The method according to claim 24, wherein the baggage is moved from the link platform to a baggage conveyor.
